(19) United States
(12) Patent Application Publication
(10) Pub. No.: US 2025/0015961 A1
(43) Pub. Date: Jan. 9, 2025

(54) FRAMEWORKS FOR TIMING INFORMATION SETUP AND EXCHANGE IN WIRELESS NETWORKS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Plano, TX (US); Yue Qi, Plano, TX (US); Elliot Jen, Taipei City (TW)

(21) Appl. No.: 18/751,112

(22) Filed: Jun. 21, 2024

Related U.S. Application Data
(60) Provisional application No. 63/524,996, filed on Jul. 5, 2023.

(51) Int. Cl. H04L 5/00; H04L 47/28; H04W 84/12

(52) U.S. Cl. CPC H04L 5/0078; H04L 47/28; H04W 84/12

(57) ABSTRACT

A first device associated with a second device in a wireless network, the first device comprising at least one station (STA) affiliated with the first device and a processor coupled to the at least one STA, the processor configured to transmit a request frame to the second device, wherein the request frame requests permission from the second device in order for the first device to provide to the second device timing information for packets transmitted to the second device, receive a response frame from the second device indicating acceptance to receive the timing information from the first device, and transmit the timing information to the second device.

### CROSS-REFERENCE TO RELATED APPLICATIONS

This application claims the benefit of priority from U.S. Provisional Application No. 63/524,996, entitled “Frameworks for Timing Information Setup and Exchange in Next Generation Wi-Fi Networks” filed Jul. 5, 2023, which is incorporated herein by reference in its entirety.

### TECHNICAL FIELD

This disclosure relates generally to a wireless communication system, and more particularly to, for example, but not limited to, timing information setup and exchange procedures in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a first device associated with a second device in a wireless network. The first device includes at least one station (STA) affiliated with the first device and a processor coupled to the at least one STA. The processor is configured to transmit a request frame to the second device, wherein the request frame requests permission from the second device in order for the first device to provide to the second device timing information related to packet expiration times for packets transmitted to the second device. The processor is configured to receive a response frame from the second device indicating acceptance to receive the timing information from the first device. The processor is configured to transmit the timing information to the second device.

In some embodiments, a plurality of links are established between the first device and the second device and the timing information is information for packets associated with a particular link from the plurality of links between the first device and the second device.

In some embodiments, the process is further configured to determine that a first link between the first device and the second device is congested, transmit the request frame and receive the response frame on a second link between the first device and the second device, and transmit the timing information on the first link between the first device and the second device.

In some embodiments, the request frame and the timing information are transmitted on different links.

In some embodiments, the request frame and the timing information are transmitted on a same link.

In some embodiments, the timing information is transmitted on an on-demand basis as determined by the first device based on traffic conditions between the first device and the second device.

In some embodiments, the timing information is transmitted after receipt of a trigger frame from the second device.

In some embodiments, the STA is an access point (AP) STA or a non-AP STA.

In some embodiments, the processor is further configured to advertise a capability to provide the timing information to the second device.

In some embodiments, the processor is further configured to receive an unsolicited authorization frame from a third device, and transmit the timing information to the third device.

One aspect of the present disclosure provides a first device associated with a second device in a wireless network. The first device includes at least one station (STA) affiliated with the first device and a processor coupled to the at least one STA. The processor is configured to transmit a request frame to the second device, wherein the request frame requests that the second device provide timing information related to packet expiration times for packets transmitted to the first device. The processor is configured to receive a response frame from the second device indicating acceptance to provide the timing information to the first device. The processor is configured to receive the timing information from the second device.

In some embodiments, plurality of links are established between the first device and the second device and the timing information is information for packets associated with a particular link from the plurality of links between the first device and the second device.

In some embodiments, the processor is further configured to determine that a first link between the first device and the second device is congested, transmit the request frame and receive the response frame on a second link between the first device and the second device, and receive the timing information on the first link between the first device and the second device.

In some embodiments, the request frame and the timing information are communicated on different links.

In some embodiments, the request frame and the timing information are communicated on a same link.

In some embodiments, the timing information is requested on an on-demand basis as determined by the first device based on traffic conditions between the first device and the second device.

In some embodiments, the timing information is received after transmission of a trigger frame from the first device.

In some embodiments, the STA is an access point (AP) STA or a non-AP STA.

In some embodiments, the processor is further configured to advertise a capability to receive the timing information to the second device.

In some embodiments, the processor is further configured to transmit an unsolicited authorization frame to a third device, and receive timing information from the third device.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates a request control frame format in accordance with an embodiment.

FIG. 5 illustrates a request control field format in accordance with an embodiment.

FIG. 6 illustrates a request information field format in accordance with an embodiment.

FIG. 7 illustrates a request element format in accordance with an embodiment.

FIG. 8 illustrates an aggregate control (A-control) subfield format in accordance with an embodiment.

FIG. 9 illustrates a stream classification service (SCS) request frame format in accordance with an embodiment.

FIG. 10 illustrates a control frame format in accordance with an embodiment.

FIG. 11 illustrates a response control frame format in accordance with an embodiment.

FIG. 12 illustrates a response information format in accordance with an embodiment.

FIG. 13 illustrates an element format in accordance with an embodiment.

FIG. 14 illustrates an A-control subfield format in accordance with an embodiment.

FIG. 15 illustrates an SCS response frame in accordance with an embodiment.

FIG. 16 illustrates an SCS response frame in accordance with an embodiment.

FIG. 17 illustrates an example operation of negotiation request and response in accordance with an embodiment.

FIG. 18 illustrates an example operation using negotiation request and response frames in accordance with an embodiment.

FIG. 19 illustrates an example operation using A-control subfield in accordance with an embodiment.

FIG. 20 illustrates an example operation using A-control subfield variant on different links in accordance with an embodiment.

FIG. 21 illustrates an example operation using a request element in accordance with an embodiment.

FIG. 22 illustrates a control frame format in accordance with an embodiment.

FIG. 23 illustrates an authorization control field format in accordance with an embodiment.

FIG. 24 illustrates an authorization field format in accordance with an embodiment.

FIG. 25 illustrates an authorization element in accordance with an embodiment.

FIG. 26 illustrates an A-control subfield variant format in accordance with an embodiment.

FIG. 27 illustrates an example of unsolicited authorization frame operation in accordance with an embodiment.

FIG. 28 illustrates an example operation using an authorization element in accordance with an embodiment.

FIG. 29 illustrates an example operation using SCS request and response frames in accordance with an embodiment.

FIG. 30 illustrates an example using an A-control subfield variant in accordance with an embodiment.

FIG. 31 illustrates a trigger dependent user info format in accordance with an embodiment.

FIG. 32 illustrates a triggering example in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

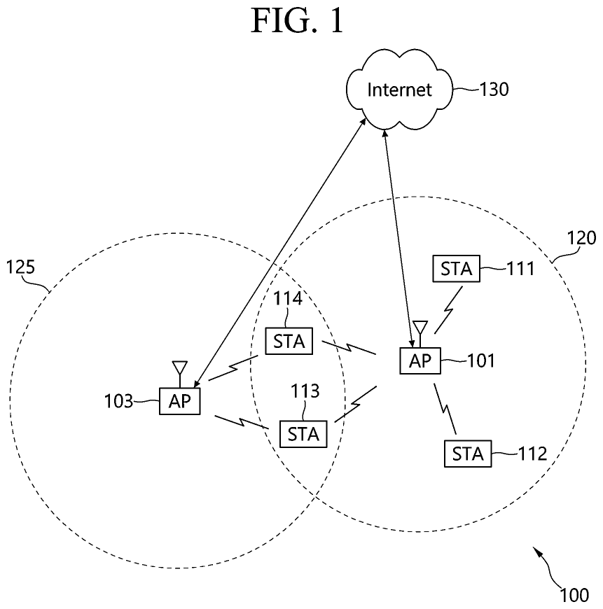

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

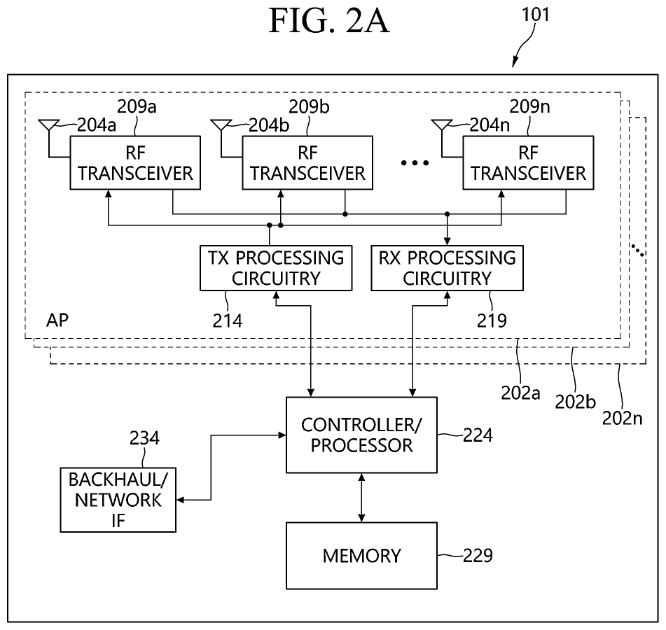

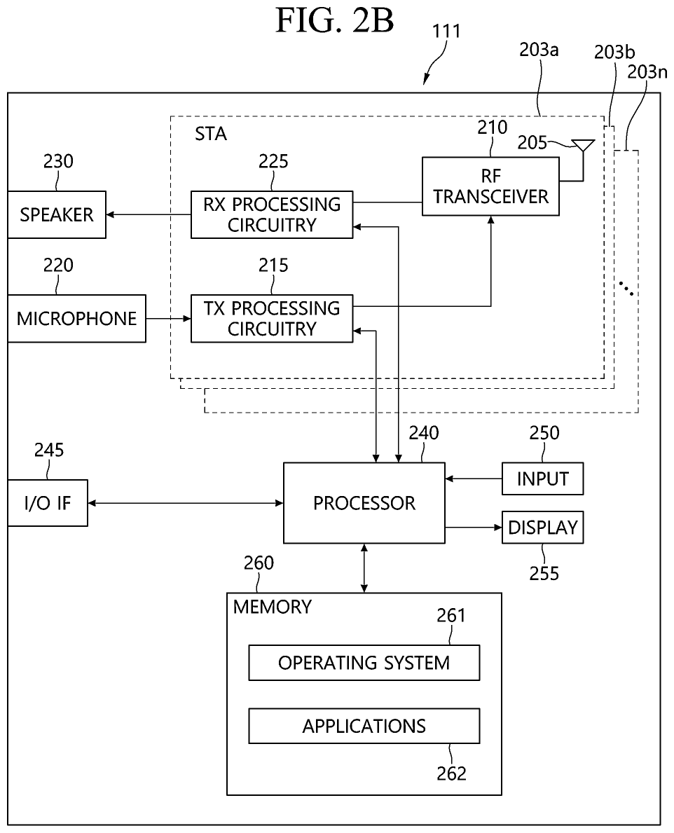

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

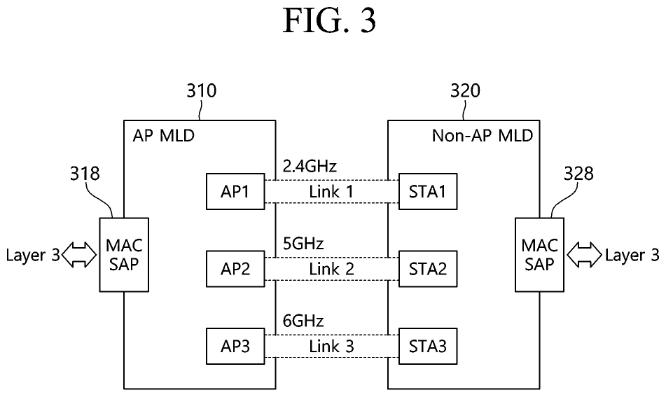

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications” and ii) IEEE P802.11be/D3.0, “Wireless LAN Medium Access Control (MAC) and Physical Layer (PHY) Specifications.”

Many embodiments provide for reducing latency and improving communication in next generation wireless networks. In particular, knowledge of timing information from the STA side can enable an AP to meet the latency and packet loss requirements for the STA. For instance, if the AP knows the time when the packet gets enqueued at the STA side or the packet's expiry time, the AP can take actions to ensure that the packet can be served before the packet expiration time.

However, for an STA to be able to report the timing information, there can be some overhead and it may not be desirable to incur this overhead for every packet for every STA. Therefore, many embodiments of the disclosure herein provide procedure(s) for setup of timing information reporting between the AP and the STA. The procedure can determine the parameters of reporting such as which STAs can report timing information to the AP, for what types of traffic, among other parameters.

In some embodiments, a negotiation based procedure can be used to setup the reporting. In some embodiments, a requesting entity can transmit a negotiation request frame to a responding entity. A negotiation request frame can include at least one or more of the information items as indicated in Table 1.

TABLE 1

| Information item | Description |
|---|---|
| Requesting entity | An information item that can describe who the |
| identifier | requesting entity is. e.g., the MAC address, |
| | AID in case of STA, among others. |
| Responding entity | An information item that can describe who the |
| identifier | responding entity is. e.g., the MAC address, |
| | BSSID in case of AP, among others |
| Request reference | An information item that can serve as a |
| | reference for the request frame. The |
| | responding entity can use this reference in |
| | its response so that the requesting |
| | entity can know what request frame it |
| | corresponds to. e.g., a dialog token. |
| Reason | An information item that can indicate the |
| information | reason for sending this frame. e.g., a |
| | reason code. |
| Request duration | An information item that can describe the |
| | duration for which the request holds good. |
| | After this time the negotiation has to be |
| | done again. e.g., a request expiration timer. |
| Response | An information item that can indicate if a |
| requirement | response is needed for the request frame. e.g., |
| | a field (such as a bit) which can take a |
| | predetermined value (such as 1) to make the |
| | indication of a response requirement and |
| | another predetermined value (such as 0) to |
| | indicate otherwise. |
| Traffic | An information item that can describe |
| information | what packet(s)/frame(s) this information can |
| | be reported for. e.g., TID information, |
| | access category (AC) information, SCS ID |
| | information, traffic type such as EPCS |
| | traffic, low latency traffic, specific packets |
| | such as head of the line (HOL) packet, |
| | among others. |
| Link information | An information item that can describe what |
| | link(s) the information can be reported on. |
| | e.g., link ID, link ID bitmap, among others. |
| Reporting | An information item that can describe how |
| frequency | frequently the information can be reported. |
| | e.g., ever beacon interval or during indicated |
| | beacon intervals, every transmission, every |
| | predefined period, among others. |
| Reporting | An information item that can describe what |
| information | can be reported. e.g., enqueue time, expiration |
| | timer, expiration time, worse case delay, |
| | among others. |
| Statistic type | An information item that can describe what type |
| | of timing information can be reported. e.g., |
| | the raw timing information for one or more |
| | packet(s)/frame(s), average value of timing |
| | information over a time window, among others. |
| Reporting | An information item that can describe the |
| condition(s) | condition(s) under which the reporting can be done. |
| | e.g., when requested by the AP, when the STA faces |
| | performance degradation (due to congestion, packet |
| | losses, longer delays, among others), among others. |

The above information item(s) can be carried in a single frame or in one or more than one frame. The above information item(s) can be carried in newly defined frames/elements/subfields or in any of the existing frames/elements/subfields in the standard. A few examples are provided below.

In some embodiments, one or more of the above information items of table 1 can be carried in a control frame.

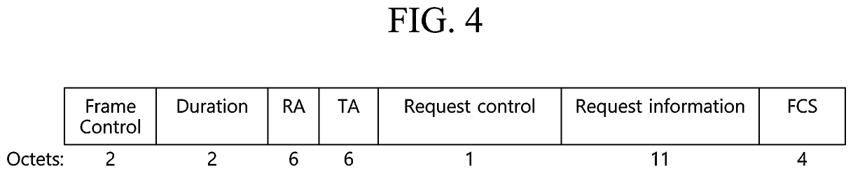

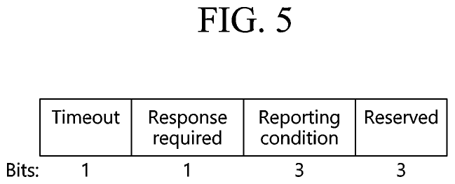

FIG. 4 illustrates a request control frame format in accordance with an embodiment. The request control frame can include a frame control field, a duration field, a receiver address (RA) field, a transmitter address (TA) field, a request control field, a request information field, and a FCS field. The frame control field may control the frame. The duration field may provide duration information. The RA field may provide a receiver address. The TA field may provide a transmitter address. The request control field may include timing information and have a format as shown in FIG. 5. The request information field may identify information that is being requested. The FCS field may provide information regarding a frame control subfield.

FIG. 5 illustrates a request control field format in accordance with an embodiment. The request control field format may include a timeout field, a response required field, a reporting condition field, and a reserved field. The timeout bit can be set to 1 if the request information field in FIG. 4 includes the request timeout field. It can be set to 0 otherwise. The response required bit can be set to 1 if the request requires a response and can be set to 0 otherwise. When a response is not required the request can establish the setup. The reporting condition field can be an encoding such as the one shown in Table 2. The reserved field may be reserved.

TABLE 2

| Bit value | Meaning |
|---|---|
| 000 | Responding entity can report timing information |
| | for all the frames |
| 001 | Responding entity can report timing information |
| | when requested by the requesting entity. |
| 010 | Responding entity can report timing information |
| | when it detects a congestion |
| 011 | Responding entity can report timing information |
| | when it detects a large delay |
| 100 | Responder can report timing information when it |
| | detects a large packet drop |
| 101-111 | Reserved |

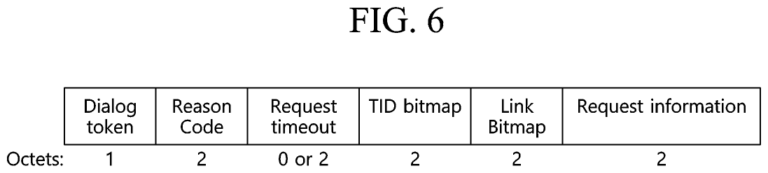

The request information field can have a format as shown in FIG. 6.

FIG. 6 illustrates a request information field format in accordance with an embodiment. The request information field format can include a dialog token field, a reason code field, a request timeout field, a TID bitmap field, a link bitmap field, and a reporting information field. The dialog token field can be used for matching request with the response. The dialog token field can be set to a value that is chosen by the requestor sending the request to identify the request/response transaction. The reason code field can indicate the reason for generating the request. The request timeout field can indicate the duration after which the request can timeout.

The TID bitmap field can indicate the TIDs for which the reporting can be done. A value of 1 in the bit position i of the TID bitmap can indicate to the responding entity that the requesting entity is requesting to report timing information for packets that correspond to TID i. A value of 0 in the bit position i of the bitmap can indicate to the responding entity that the requesting entity is not requesting to report timing information for packets that correspond to TID i.

The link bitmap field can indicate the link(s) on which the reporting can be done. A value of 1 in the bit position i of the link bitmap can indicate to the responding entity that the requesting entity is requesting reporting for the link with link ID equal to i. A value of 0 in the bit position i of the link bitmap can indicate to the responding entity that the requesting entity is not requesting reporting for link with link ID equal to i. The reporting information field can carry an encoding that an indicate what type of timing information is being requested to be reported.

In some embodiments, a request can be made through an element.

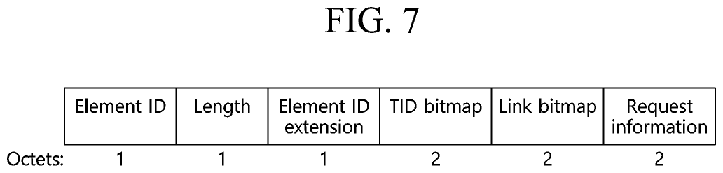

FIG. 7 illustrates a request element format in accordance with an embodiment. The request element format may include an element ID field, a length field, an element ID extension field, a TID bitmap field, a link bitmap field, and a reporting information field.

The element ID can provide an identifier for the request element. The length field can provide a length of the request element. The element ID extension field may provide an element ID extension for the request element.

The TID bitmap field can indicate the TIDs for which the reporting can be done. A value of 1 in the bit position i of the TID bitmap can indicate to the responding entity that the requesting entity is requesting to report timing information for packets that correspond to TID i. A value of 0 in the bit position i of the bitmap can indicate to the responding entity that the requesting entity is not requesting to report timing information for packets that correspond to TID i.

The link bitmap field can indicate the link(s) on which the reporting can be done. A value of 1 in the bit position i of the link bitmap can indicate to the responding entity that the requesting entity is requesting reporting for the link with link ID equal to i. A value of 0 in the bit position i of the link bitmap can indicate to the responding entity that the requesting entity is not requesting reporting for link with link ID equal to i.

The reporting information field can carry an encoding that may indicate what type of timing information is being requested to be reported.

In some embodiment, the above information can be carried in an action frame. The action frame can have a format as shown in Table 3.

TABLE 3

| Order | Information |
|---|---|
| 1 | Category |
| 2 | Protected Action |
| 3 | Dialog Token |
| 4 | Request element |

The category field may indicate the category of the action frame.

The protected action field may differentiate the protected action frame formats.

The dialog token field can be a non-zero value that can be chosen by the requesting entity of the frame to identify the request/response transaction.

The request element field may have a format as shown in FIG. 7.

In some embodiments, an A-control subfield can be used to make a request.

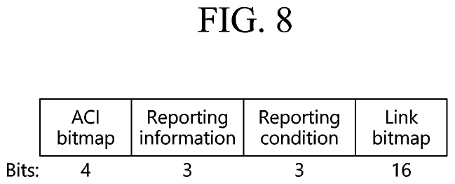

FIG. 8 illustrates an A-control subfield format in accordance with an embodiment. The A-control subfield format can include an ACI bitmap field, a reporting information field, a reporting condition field, and a link bitmap field.

The ACI Bitmap field can indicate the ACs for which the report is being requested. Each bit in the ACI bitmap can correspond to one AC. For instance, bit 0 can correspond to AC_BE, bit 1 can correspond to AC_BK, bit 2 can correspond to AC_VI and bit 3 can correspond to AC_VO.

The reporting information field can have an encoding to indicate the information that the responding entity can generate as a part of the report.

The reporting condition field can provide timing information and have an encoding as shown in Table 2.

The link bitmap field can indicate the link(s) on which the reporting can be done. A value of 1 in the bit position i of the link bitmap can indicate to the responding entity that the requesting entity is requesting reporting for the link with link ID equal to i. A value of 0 in the bit position i of the link bitmap can indicate to the responding entity that the requesting entity is not requesting reporting for link with link ID equal to i.

In some embodiments, an SCS request frame can be used.

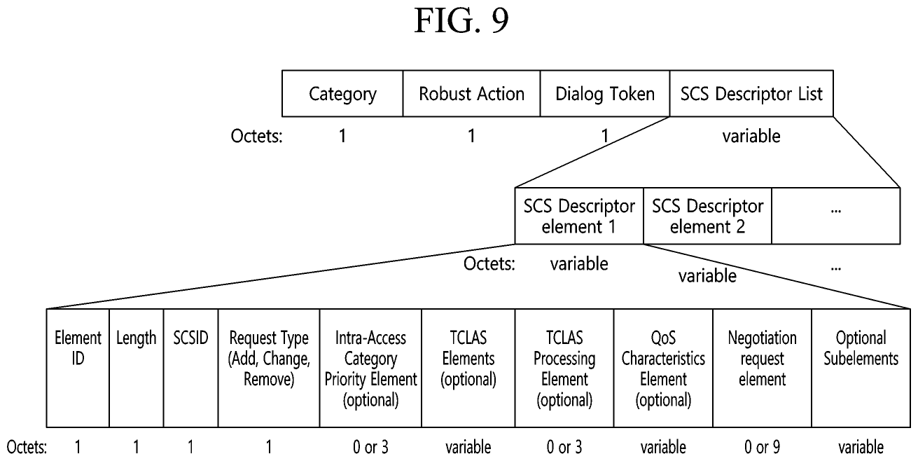

FIG. 9 illustrates an SCS request frame format in accordance with an embodiment. In particular, as illustrated, the SCS descriptor list field can include an SCS descriptor element that may include a negotiation request element such as the one shown in FIG. 7. Thus, the reporting can be done for at least one or more TIDs that belong to a stream. The SCS request frame format may include a Category field, a Robust Action field, a Dialog Token field, and an SCS descriptor list field.

The Category field may be set to a value that indicates a category of the SCS request frame that is an action frame. The Robust Action field may have a value associated with the SCR request frame format within predefined robust AV streaming category. The Dialog Token field may be used for matching action response with action requests when there are multiple, concurrent action requests. The SCS Descriptor List field may include one or more SCS Descriptor elements.

In particular, the SCS Descriptor element can include an Element ID field, Length field, SCSID field, Request Type field, Intra-Access Category Priority element field (optional), TCLAS elements field (optional), TCLAS processing element field (optional), QoS Characteristics element field (optional), a negotiation request element, and Optional Sub elements field.

The Element ID field may include information to identify a type of the SCS Descriptor element. The Length field may indicate a length of the SCS Descriptor element. The SCSID field may include information to identify the SCS descriptor element. The Request Type field can be set to indicate the request type (i.e., Add, Remove, and Change) of the SCS descriptor element. The Intra-Access Category Priority element field may be present when the Request Type field is equal to “Add” or “Change.” The TCLAS element field may include information on a traffic classification. The TCLAS processing element field may include information on a method of processing a traffic from an upper layer. The QoS Characteristics element field may include a set of parameters that define the characteristics and QoS expectations of a traffic flow.

The negotiation request element field may report timing information and include a format as illustrated in FIG. 7. The optional sub-elements field may include optional sub-elements.

In some embodiments, upon receiving the request frame, the responding entity can transmit a response frame. The negotiation response frame can include at least one or more of the information items as indicated in Table 4.

TABLE 4

| Information item | Description |
|---|---|
| Requesting entity | An information item that can describe who |
| identifier | the requesting entity is. e.g., the MAC |
| | address, AID in case of STA, among others |
| Responding entity | An information item that can describe who |
| identifier | the responding entity is. e.g., the MAC |
| | address, BSSID in case of AP, among others |
| Request reference | An information item that can that can |
| | indicate what request the frame |
| | corresponds to. e.g., a dialog token. |
| Reason | An information item that can indicate |
| information | the reason for sending this frame. e.g., |
| | a reason code. |
| Negotiation | An information item that can describe |
| duration | the duration for which the negotiation |
| | holds good. After this time the |
| | negotiation has to be done again. e.g., |
| | a negotiation expiration timer. |
| Traffic | An information item that can describe |
| information | what packet(s)/frame(s) this information |
| | can be reported for. e.g., TID information, |
| | access category (AC) information, SCS ID |
| | information, traffic type such as EPCS |
| | traffic, low latency traffic, specific |
| | packets such as head of the line (HOL) |
| | packet, among others |
| Link information | An information item that can describe what |
| | link(s) the information can be reported on. |
| | e.g., link ID, link ID bitmap, among others |
| Reporting | An information item that can describe how |
| frequency | frequently the information can be reported. |
| | e.g., ever beacon interval or during |
| | indicated beacon intervals, every |
| | transmission, every predefined period, |
| | among others |
| Reporting | An information item that can describe what |
| information | can be reported. E.g., enqueue time, |
| | expiration timer, expiration time, worse |
| | case delay, among others |
| Statistic type | An information item that can describe what |
| | type of timing information can be reported. |
| | e.g., the raw timing information for one |
| | or more packet(s)/frame(s), average value |
| | of timing information over a time window, |
| | among others |
| Reporting | An information item that can describe the |
| condition(s) | condition(s) under which the reporting can |
| | be done. e.g., when requested by the AP, |
| | when the STA faces performance degradation |
| | (due to congestion, packet losses, longer |
| | delays, among others), among others |
| Request status | An information item that can indicate |
| | the status of the request. E.g., a status |
| | code |

The above information item(s) can be carried in a single frame or in one or more than one frame. The above information item(s) can be carried in newly defined frames/elements/subfields or in any of the existing frames/elements/subfields in the standard. A few examples are provided below.

In some embodiments, the response frame can be a control frame.

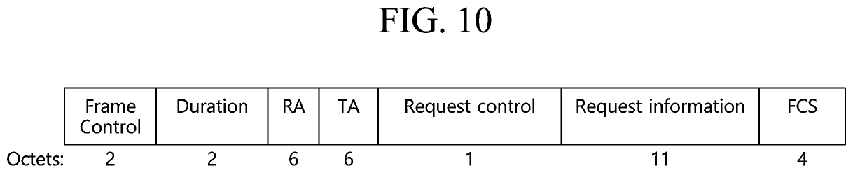

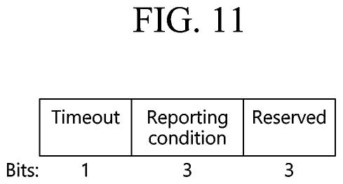

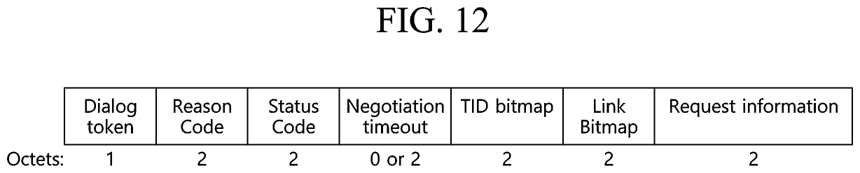

FIG. 10 illustrates a control frame format in accordance with an embodiment. The control frame format may include a frame control field, a duration field, an RA field, a TA field, a response control field, a response information field, and a FCS. The fields can be the same as or similar to the fields of the request control frame described in FIG. 4. The frame control field may control the frame. The duration field may provide duration information. The RA field may provide a receiver address. The TA field may provide a transmitter address. The response control field may include timing information and have a format as shown in FIG. 11. The response information field may provide timing information and may have a format as shown in FIG. 12. The FCS field may provide information regarding a frame control subfield.

FIG. 11 illustrates a response control frame format in accordance with an embodiment. The response control frame may include a timeout field, a reporting condition field, and a reserved field. The timeout bit field can be set to 1 if the negotiation timeout value is present in response information field. It can be set to 0 if the field is not present. The reporting condition field can indicate the conditions under which the responding entity agrees with the reporting to take place. The reserved field may be reserved.

FIG. 12 illustrates a response information format in accordance with an embodiment. The response information format may include a dialog token field, a reason code field, a status code field, a negotiation timeout field, a TID bitmap field, a link bitmap field, and a reporting information field.

The dialog token field can be used for matching request with the response. The dialog token field can be set to a value that is chosen by the requestor sending the request to identify the request/response transaction.

The reason code field can indicate the reason for generating the request.

The status code field can indicate the status of the request.

The negotiation timeout field can indicate the duration after which the negotiation can timeout. After this time, another negotiation can be needed for the reporting.

The TID bitmap field can indicate the TIDs for which the reporting can be done. A value of 1 in the bit position i of the TID bitmap can indicate to the requesting entity that the timing information for packets that correspond to TID i can be provided. A value of 0 in the bit position i of the bitmap can indicate to the requesting entity that the timing information for packets that correspond to TID i cannot be provided.

The link bitmap field can indicate the link(s) on which the reporting can be done. A value of 1 in the bit position i of the link bitmap can indicate to the requesting entity that the timing information can be reported for the link with link ID equal to i. A value of 0 in the bit position i of the link bitmap can indicate to the requesting entity that the timing information cannot be reported for link with link ID equal to i.

The reporting information field can carry an encoding that an indicate what type of timing information can be reported.

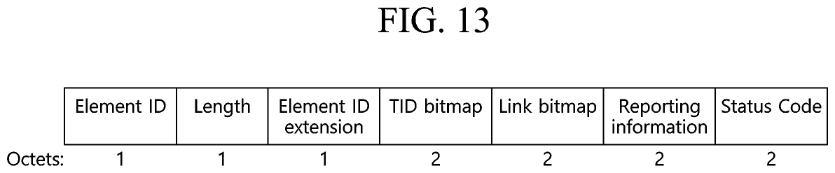

In some embodiments, an element can be used. The element can have a format as shown in FIG. 13.

FIG. 13 illustrates an element format in accordance with an embodiment. The element format may include an element ID field, a length field, an element ID extension field, a TID bitmap field, a link bitmap field, a reporting information field, and a status code field.

The element ID can provide an identifier for the request element. The length field can provide a length of the request element. The element ID extension field may provide an element ID extension for the request element.

The TID bitmap field can indicate the TIDs for which the reporting can be done. A value of 1 in the bit position i of the TID bitmap can indicate to the requesting entity that the responding entity can report timing information for packets that correspond to TID i. A value of 0 in the bit position i of the bitmap can indicate to the requesting entity that the responding entity cannot report timing information for packets that correspond to TID i.

The link bitmap field can indicate the link(s) on which the reporting can be done. A value of 1 in the bit position i of the link bitmap can indicate to the requesting entity that the responding entity can report for the link with link ID equal to i. A value of 0 in the bit position i of the link bitmap can indicate to the requesting entity that the responding entity cannot report for link with link ID equal to i.

The reporting information field can carry an encoding that man indicate what type of timing information can be reported.

The status code field can indicate the status of the request.

In some embodiments, the above information can be carried in an action frame. The action frame can have a format as shown in Table 5.

TABLE 5

| Order | Information |
|---|---|
| 1 | Category |
| 2 | Protected Action |
| 3 | Dialog Token |
| 4 | Status code |
| 5 | Response element |

The category field may indicate the category of the action frame.

The protected action field can enable to differentiate the protected action frame formats.

The dialog token field can be a non-zero value that can be chosen by the requesting entity of the frame to identify the request/response transaction.

The status code field can indicate the status of the request. E.g., a status code indicating success can be used in case the responding entity accepts the request of the requesting entity.

The response element can have a format as shown in FIG. 13.

In some embodiments, a control subfield variant of an A-control subfield can be used.

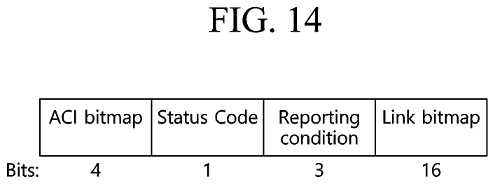

FIG. 14 illustrates an A-control subfield format in accordance with an embodiment. The A-control subfield format may include an ACI bitmap field, a status code field, a reporting condition field, and a link bitmap field.

The ACI Bitmap field can indicate the ACs for which the report is being requested. Each bit in the ACI bitmap can correspond to one AC. For instance, bit 0 can correspond to AC_BE, bit 1 can correspond to AC_BK, bit 2 can correspond to AC_VI and bit 3 can correspond to AC_VO.

The status code field can take a value of 1 to indicate success and a value of 0 to indicate failure.

The reporting information field may provide timing information and may have an encoding as shown in Table 2.

The link bitmap field can indicate the link(s) on which the reporting can be done. A value of 1 in the bit position i of the link bitmap can indicate to the responding entity that the requesting entity is requesting reporting for the link with link ID equal to i. A value of 0 in the bit position i of the link bitmap can indicate to the responding entity that the requesting entity is not requesting reporting for link with link ID equal to i.

In some embodiments, a modified SCS response frame can be used.

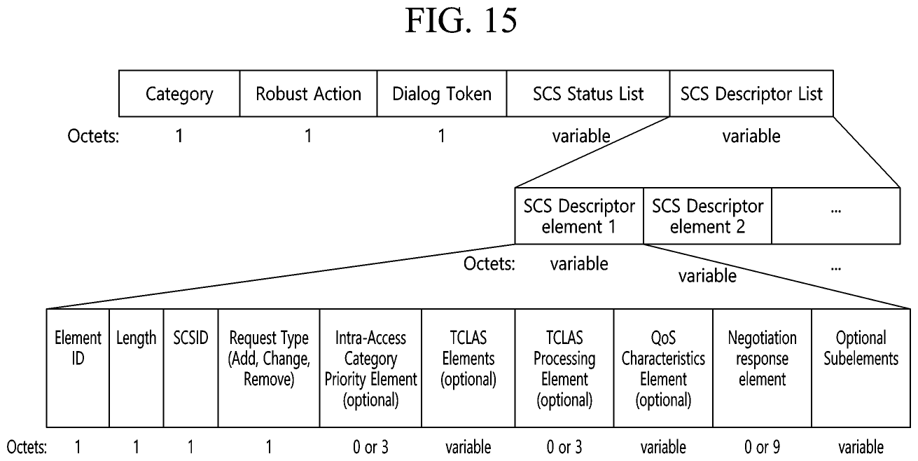

FIG. 15 illustrates an SCS response frame in accordance with an embodiment. As depicted, there can be a negotiation response element that can be carried in the SCS descriptor list of the SCS response frame. The negotiation response element can carry information such as that shown in FIG. 13. The fields of the SCS response frame can be similar to the fields of the SCS request frame described in FIG. 9.

In some embodiments, instead of transmitting the response information using the negotiation response element, a timing info request status list can be included in the SCS response frame.

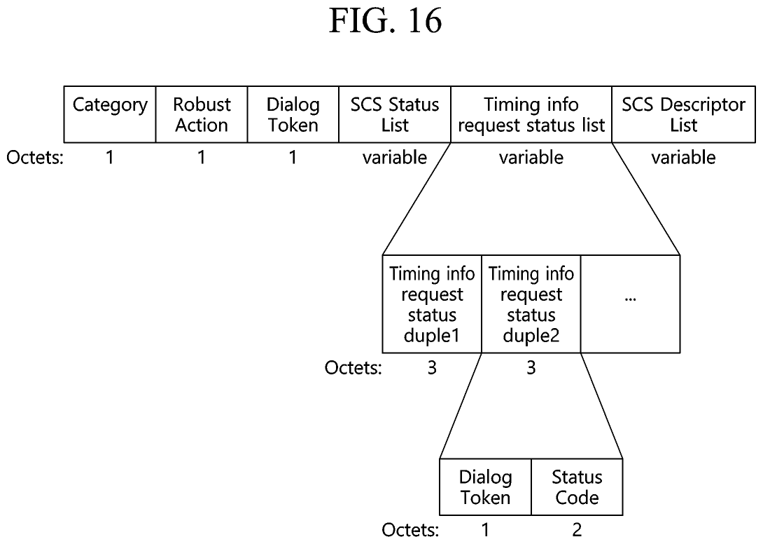

FIG. 16 illustrates an SCS response frame in accordance with an embodiment. The SCS response frame can include a Category field, a Robust Action field, a Dialog Token field, a SCS Status list field, a timing information request status list field, and an SCS descriptor list field.

The Category field may be set to a value that indicates a category of the SCS request frame that is an action frame. The Robust Action field may have a value associated with the SCR request frame format within predefined robust AV streaming category. The Dialog Token field may be used for matching action response with action requests when there are multiple, concurrent action requests. The SCS status list may provide status information. The timing info request status list field can include several subfields as illustrated and described below. The SCS Descriptor List field may include one or more SCS Descriptor elements.

The timing info request status list field can have a format as depicted in the figure. As illustrated, the list can carry status duples, illustrated as timing info request status duple1, timing info request status double 2, and continued. Each duple can include a dialog token field and a status code field for each timing info request status that is made in the SCS request frame. The dialog token may be used for matching action response with action requests when there are multiple, concurrent action requests. The status code may provide a status.

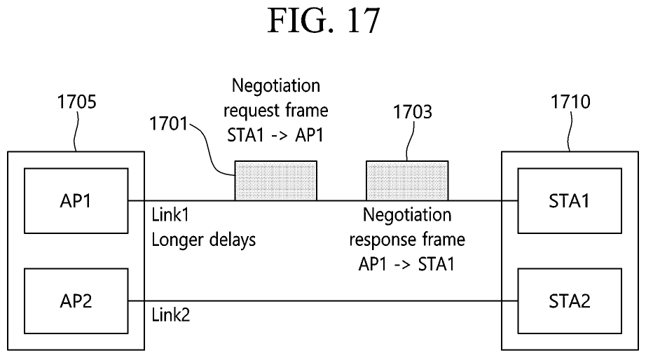

FIG. 17 illustrates an example operation of negotiation request and response in accordance with an embodiment. In particular, FIG. 17 illustrates AP1 and AP2 affiliated with AP MLD 1705 and STA1 and STA2 affiliated with non-AP MLD 1710 . . . . Furthermore, FIG. 17 illustrates communication between STA1 associated with AP1 on link 1 and STA2 associated with AP2 on link 2.

In one example as shown in FIG. 17, suppose that STA1 is facing longer delays on link 1 and wants to transmit timing information on link 1 to gain AP1's assistance to reduce the latency that its packets can face. It transmits a negotiation request frame 1701 which can either be a control frame or an action frame to AP1. Upon receiving the request from STA1, AP1 processes the request and transmits a negotiation response frame 1703 to STA. Upon receiving AP1's negotiation response frame 1703, STA1 starts to report timing information to the AP.

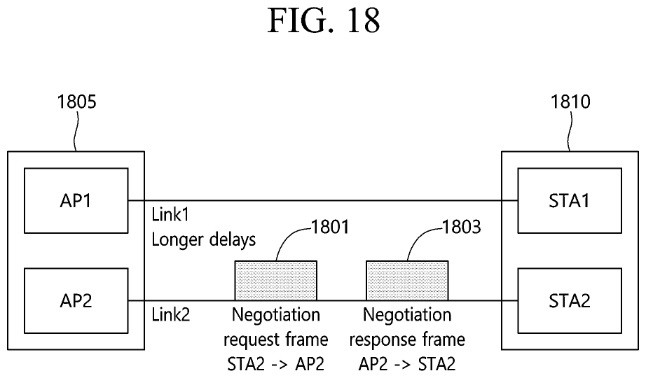

FIG. 18 illustrates an example operation using negotiation request and response frames in accordance with an embodiment. In particular, FIG. 18 illustrates AP1 and AP2 affiliated with AP MLD 1805 and STA1 and STA2 affiliated with non-AP MLD 1810. Furthermore, FIG. 18 illustrates communication between STA1 associated with AP1 on link 1 and STA2 associated with AP2 on link 2. In the example shown in FIG. 18, suppose that STA1 is facing congestion on link 1 and wants to transmit timing information on link to gain AP1's assistance to reduce the latency that its packets can face. Instead of transmitting the negotiation request frame on link1, STA1 can transmit the negotiation request frame 1801 on link 2 via STA2, for reporting timing information for packets on link 1. Upon receiving the request frame, the request frame can be processed and the response frame 1803 can be transmitted on link 2 via AP2. Upon receiving the response frame, STA1 can start reporting the timing information on link 1.

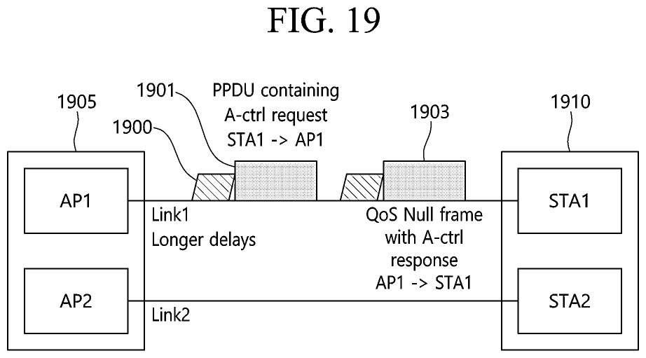

FIG. 19 illustrates an example operation using A-control subfield in accordance with an embodiment. In particular, FIG. 19 illustrates AP1 and AP2 affiliated with AP MLD 1905 and STA1 and STA2 affiliated with non-AP MLD 1910. Furthermore, FIG. 19 illustrates communication between STA1 associated with AP1 on link 1 and STA2 associated with AP2 on link 2. As illustrated in FIG. 19, link 1 is facing longer delays. STA1 transmits a contention window 1900 for a backoff process to AP1. STA1 transmits an A-control based request subfield in an ongoing PPDU transmission 1901 to AP1. Upon receiving the PPDU carrying the A-control request subfield, AP1 processes the subfield and transmits a QoS Null frame 1903 that includes the A-control response subfield to STA1. Upon receiving the response subfield carrying an affirmative response from AP1, STA1 starts reporting timing information to AP1 on link 1.

In some embodiments, the negotiation request and response can be done through A-control subfield based request and response subfield variants.

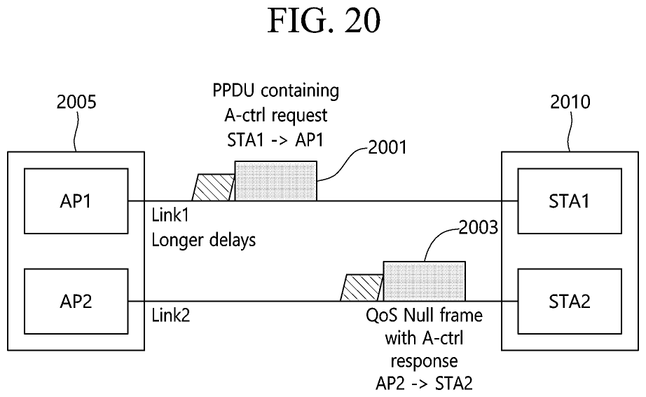

FIG. 20 illustrates an example operation using A-control subfield variant on different links in accordance with an embodiment. In particular, FIG. 20 illustrates AP1 and AP2 affiliated with AP MLD 2005 and STA1 and STA2 affiliated with non-AP MLD 2010. Furthermore, FIG. 20 illustrates communication between STA1 associated with AP1 on link 1 and STA2 associated with AP2 on link 2. As illustrated in FIG. 20, link 1 is facing longer delays. STA1 transmits a PPDU 2001 carrying an A-control based request subfield in an ongoing PPDU transmission to AP1. Upon receiving the PPDU 2001 carrying the A-control field on link 1, AP2 transmits the response QoS Null Frame 2003 with A-control subfield frame 2003 on link 2.

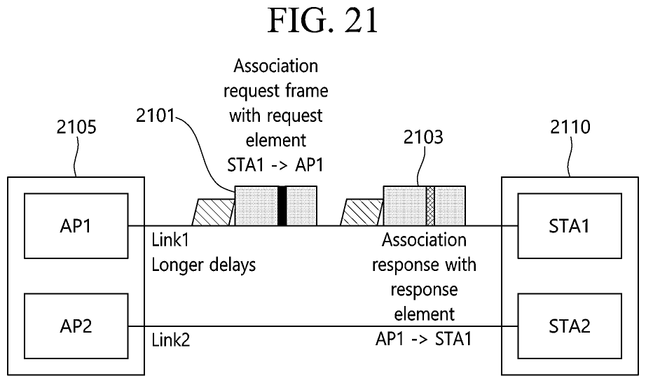

FIG. 21 illustrates an example operation using a request element in accordance with an embodiment. In particular, FIG. 21 illustrates AP1 and AP2 affiliated with AP MLD 2105 and STA1 and STA2 affiliated with non-AP MLD 2110. Furthermore, FIG. 21 illustrates communication between STA1 associated with AP1 on link 1 and STA2 associated with AP2 on link 2. As illustrated in FIG. 21, link 1 is facing longer delays. STA1 transmits the request element which can be carried in a management frame such as an association request frame 2101 transmitted by the STA during association. Upon receiving the association request frame, the AP can include the response element in the association response frame 2103 transmitted to the STA.

In some embodiments, a first entity can transmit an unsolicited authorization frame to a second entity to enable the second entity to start reporting timing information to the first entity. Upon receiving the authorization, the second entity can transmit timing information report to the first entity. The authorization frame can include at least one or more of the information items as indicated in Table 6.

TABLE 6

| Information item | Description |
|---|---|
| Requesting entity | An information item that can describe who the |
| identifier | requesting entity is. e.g., the MAC address, |
| | AID in case of STA, among others |
| Responding entity | An information item that can describe who the |
| identifier | responding entity is. e.g., the MAC address, |
| | BSSID in case of AP, among others |
| Reason | An information item that can indicate the |
| information | reason for sending this frame. e.g., a |
| | reason code. |
| Authorization | An information item that can describe the |
| duration | duration for which the authorization holds |
| | good. After this time another authorization |
| | can be needed. e.g., an expiration timer. |
| Traffic | An information item that can describe what |
| information | packet(s)/frame(s) this information can be |
| | reported for. e.g., TID information, access |
| | category (AC) information, SCS ID |
| | information, traffic type such as EPCS |
| | traffic, low latency traffic, specific |
| | packets such as head of the line (HOL) |
| | packet, among others. |
| Link information | An information item that can describe what |
| | link(s) the information can be reported on. |
| | e.g., link ID, link ID bitmap, among others. |
| Reporting | An information item that can describe how |
| frequency | frequently the information can be reported. |
| | E.g., ever beacon interval or during |
| | indicated beacon intervals, every |
| | transmission, every predefined period, |
| | among others. |
| Reporting | An information item that can describe what |
| information | can be reported. e.g., enqueue time, |
| | expiration timer, expiration time, worse |
| | case delay, among others. |
| Statistic type | An information item that can describe what |
| | type of timing information can be reported. |
| | e.g., the raw timing information for one or |
| | more packet(s)/frame(s), average value of |
| | queuing delay over a time window, worse |
| | case queuing delays, best case delays, |
| | among others. |
| Reporting | An information item that can describe the |
| condition(s) | condition(s) under which the reporting can |
| | be done. e.g., when requested by the AP, |
| | when the STA faces performance degradation |
| | (due to congestion, packet losses, longer |
| | delays, among others), among others. |

The above information item(s) can be carried in a single frame or in one or more than one frame. The above information item(s) can be carried in newly defined frames/elements/subfields or in any of the existing frames/elements/subfields in the standard. A few examples are provided below

In some embodiments, the authorization frame can be a control frame.

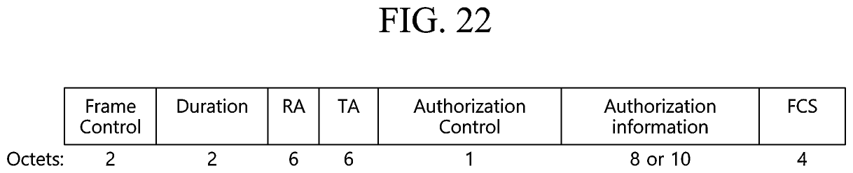

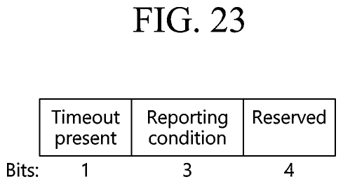

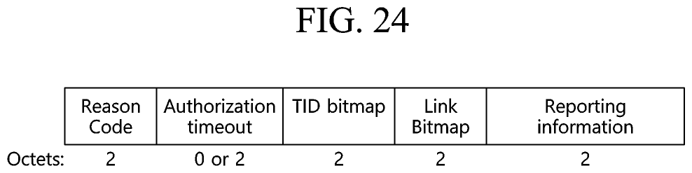

FIG. 22 illustrates a control frame format in accordance with an embodiment. The control frame format may include a frame control field, a duration field, an RA field, a TA field, a response control field, a response information field, and a FCS. The fields can be the same as or similar to the fields of the request control frame described in FIG. 4. The frame control field may control the frame. The duration field may provide duration information. The RA field may provide a receiver address. The TA field may provide a transmitter address. The authorization control field may include authorization control information and have a format as shown in FIG. 23. The authorization information field may provide authorization information and may have a format as shown in FIG. 24. The FCS field may provide information regarding a frame control subfield.

FIG. 23 illustrates an authorization control field format in accordance with an embodiment. The fields can be the same or similar to those described in FIG. 5. In particular, the authorization control field can include a timeout field,

The request control field format may include a timeout field, a reporting condition field, and a reserved field. The timeout present bit field can be set to 1 if the authorization timeout field is present in the authorization information field. It can be set to 0 otherwise. The reporting condition can have an encoding as shown in Table 2. The reserved field may be reserved.

FIG. 24 illustrates an authorization field format in accordance with an embodiment. The authorization field format may include a reason code field, an authorization timeout field, a TID bitmap field, a link bitmap field, and a reporting information field. The reason code field can indicate the reason for sending the frame. For example, a reason code that can indicate that this is an unsolicited authorization frame transmitted because the transmitting entity is expecting a congestion on the channel and wants to know the delays encountered at the receiving entity.

The authorization timeout field can take a value in time units (TU) to indicate the duration after which the authorization can expire and reporting cannot be done unless authorized again.

The TID bitmap filed can indicate the TIDs for which the reporting can be done. A value of 1 in the bit position i of the TID bitmap can indicate to the receiving entity that the timing information for packets that correspond to TID i can be provided. A value of 0 in the bit position i of the bitmap can indicate to the receiving entity that the timing information for packets that correspond to TID i need not be provided.

The link bitmap filed can indicate the link(s) on which the reporting can be done. A value of 1 in the bit position i of the link bitmap can indicate to the receiving entity that the timing information can be reported for the link with link ID equal to i. A value of 0 in the bit position i of the link bitmap can indicate to the receiving entity that the timing information cannot be reported for link with link ID equal to i.

The reporting information field can carry an encoding that may indicate what type of timing information can be reported.

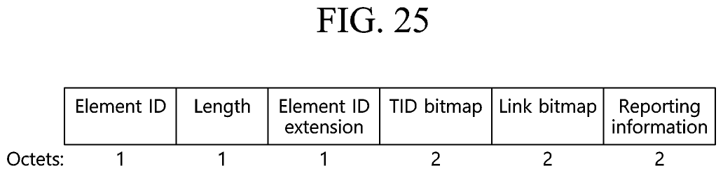

In some embodiments, the authorization element can have a format as shown in FIG. 25.

FIG. 25 illustrates an authorization element in accordance with an embodiment. The fields can the same or similar to those of the element of FIG. 7. In particular, the authorization element format may include an element ID field, a length field, an element ID extension field, a TID bitmap field, a link bitmap field, and a reporting information field.

The element ID can provide an identifier for the authorization element. The length field can provide a length of the authorization element. The element ID extension field may provide an element ID extension for the authorization element.

The TID bitmap can indicate the TIDs for which the reporting can be done. A value of 1 in the bit position i of the TID bitmap can indicate to the receiving entity that it can report timing information for packets that correspond to TID i. A value of 0 in the bit position i of the bitmap can indicate to the receiving entity that it cannot report timing information for packets that correspond to TID i.

The link bitmap can indicate the link(s) on which the reporting can be done. A value of 1 in the bit position i of the link bitmap can indicate to the receiving entity that it can report for the link with link ID equal to i. A value of 0 in the bit position i of the link bitmap can indicate to the receiving entity that it cannot report for link with link ID equal to i.

The reporting information field can carry an encoding that may indicate what type of timing information can be reported.

The element can be carried in any of the frames in the standard. (e.g., SCS response frame, among others).

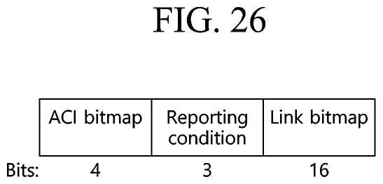

FIG. 26 illustrates an A-control subfield variant format in accordance with an embodiment. The A-control subfield variant format can include an ACI bitmap field, a reporting condition field, and a link bitmap.

The ACI Bitmap subfield can indicate the ACs for which the report can be transmitted. Each bit in the ACI bitmap can correspond to one AC. For instance, bit 0 can correspond to AC_BE, bit 1 can correspond to AC_BK, bit 2 can correspond to AC_VI and bit 3 can correspond to AC_VO.

The reporting information field can have an encoding as shown in Table 2.

The link bitmap field can indicate the link(s) on which the reporting can be done. A value of 1 in the bit position i of the link bitmap can indicate to the receiving entity that it is authorized for reporting for the link with link ID equal to i. A value of 0 in the bit position i of the link bitmap can indicate to the receiving entity that it is not authorized for reporting for link with link ID equal to i

In some embodiments, the above information can be carried in an action frame. The action frame can have a format as shown in Table 7.

TABLE 7

| Order | Information |
|---|---|
| 1 | Category |
| 2 | Protected Action |
| 5 | Authorization |
| | element |

The category field may indicate the category of the action frame.

The protected action field may enable to differentiate the protected action frame formats.

The authorization element field may provide authorization information and may have a format as shown in FIG. 25.

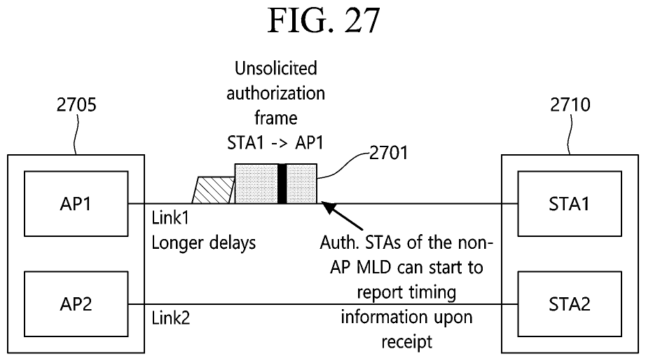

FIG. 27 illustrates an example of unsolicited authorization frame operation in accordance with an embodiment. In particular, FIG. 27 illustrates AP1 and AP2 affiliated with AP MLD 2705 and STA1 and STA2 affiliated with non-AP MLD 2710. Furthermore, FIG. 27 illustrates STA1 associated with AP1 on link 1 and STA2 associated with AP2 on link 2. As illustrated, AP1 affiliated with AP MLD can detect that link 1 is loaded with traffic. Therefore, AP1 may want to know the delays that the packets of a particular stream are facing on the STA side. AP1 can transmit an action frame 2701 to STA1 to inform STA1 that it is authorized for reporting timing information. Upon receiving the authorization from AP1, the authorized STAs of the non-AP MLD can start to report timing information.

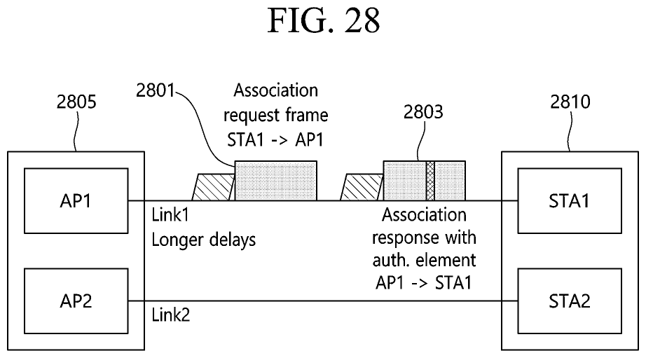

FIG. 28 illustrates an example operation using an authorization element in accordance with an embodiment. In particular, FIG. 28 illustrates AP1 and AP2 affiliated with AP MLD 2805 and STA1 and STA2 affiliated with non-AP MLD 2810. Furthermore, FIG. 28 illustrates STA1 associated with AP1 on link 1 and STA2 associated with AP2 on link 2. As illustrated, AP1 affiliated with AP MLD can detect that link 1 is loaded with traffic. During association, STA1 can transmits an associated request frame 2801 to AP1. AP1 can transmit an authorization element to STA1 in the association response frame 2803.

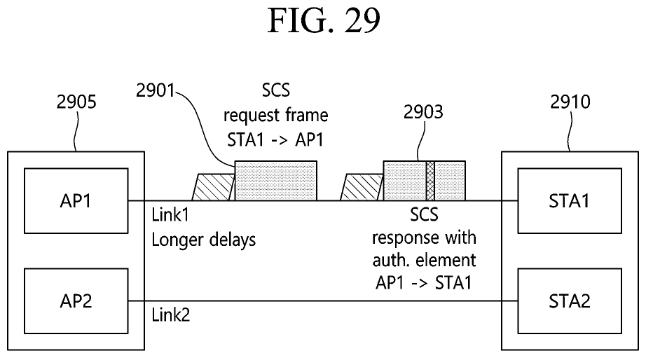

FIG. 29 illustrates an example operation using SCS request and response frames in accordance with an embodiment. In particular, FIG. 29 illustrates AP1 and AP2 affiliated with AP MLD 2905 and STA1 and STA2 affiliated with non-AP MLD 2910. Furthermore, FIG. 29 illustrates STA1 associated with AP1 on link 1 and STA2 associated with AP2 on link 2. As illustrated, AP1 affiliated with AP MLD 2905 can detect that link 1 is loaded with traffic. During SCS setup procedure, if the AP feels that the QoS requirements of the STA are such that timing information reporting is crucial for meeting the delay requirements, the AP can transmit an unsolicited authorization element as a part of the SCS response frame. As illustrated STA1 transmits an SCS request frame 2901 to AP1 and AP1 transmits an SCS response frame 2903 with an authorization element to STA1.

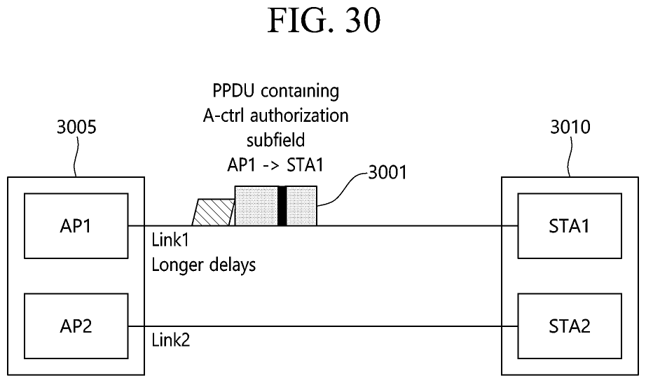

FIG. 30 illustrates an example using an A-control subfield variant in accordance with an embodiment. In particular, FIG. 30 illustrates AP1 and AP2 affiliated with AP MLD 3005 and STA1 and STA2 affiliated with non-AP MLD 3010. Furthermore, FIG. 30 illustrates STA1 associated with AP1 on link 1 and STA2 associated with AP2 on link 2. As illustrated, AP1 affiliated with AP MLD 3005 can detect that link 1 is loaded with traffic. As illustrated, AP1 can transmit a downlink (DL) PPDU 3001 that includes an unsolicited A-control subfield variant to authorize STA1 during the DL PPDU 3001 transmission

In some embodiments, there can be an on demand reporting. In some embodiments, a first entity can transmit timing information to a second entity when it considers it to be necessary. For instance, if an STA is facing longer delays and packet drops and needs the AP's assistance, it can transmit timing information to indicate to the AP about its issue as well as to provide information that can enable the AP to better assist it to meet its delay requirements.

In some embodiments, a trigger can be used to request timing information. In some embodiments, when a first entity wants timing information from a second entity, the first entity can transmit a trigger frame to the second entity. Upon receiving the trigger frame, the second entity can transmit the timing information to the first entity.

The trigger frame can include at least one or more of the information items as indicated in Table 8

TABLE 8

| Information item | Description |
|---|---|
| Requesting entity | An information item that can describe who |
| identifier | the triggering entity is. e.g., the MAC |
| | address, AID in case of STA, among others. |
| Responding entity | An information item that can describe who |
| identifier | the triggered entity is. e.g., the MAC |
| | address, BSSID in case of AP, among others. |
| Reason | An information item that can indicate the |
| information | reason for sending this frame. e.g., a |
| | reason code. |
| Traffic | An information item that can describe |
| information | what packet(s)/frame(s) this information |
| | can be reported for. e.g., TID information, |
| | access category (AC) information, SCS ID |
| | information, traffic type such as EPCS |
| | traffic, low latency traffic, specific |
| | packets such as head of the line (HOL) |
| | packet, among others. |
| Link information | An information item that can describe what |
| | link(s) the information can be reported on. |
| | e.g., link ID, link ID bitmap, among others. |
| Reporting | An information item that can describe what |
| information | can be reported. e.g., enqueue time, |
| | expiration timer, expiration time, worse |
| | case delay, among others. |
| Statistic type | An information item that can describe what |
| | type of timing information can be reported. |
| | e.g., the raw timing information for one or |
| | more packet(s)/frame(s), average value of |
| | queuing delay over a time window, worse |
| | case queuing delays, best case delays, among |
| | others. |

The above information item(s) can be carried in a single frame or in one or more than one frame. The above information item(s) can be carried in newly defined frames/elements/subfields or in any of the existing frames/elements/subfields in the standard. A few examples are provided below

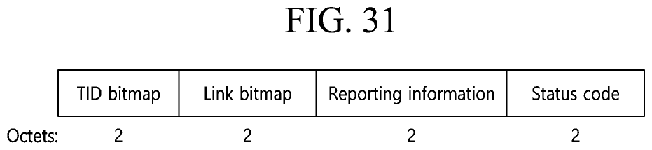

In some embodiments, a trigger frame can be used. The trigger type in the common info field can indicate that the trigger is for procuring timing information. The trigger dependent user info in the user info field in the user info list field can have a format as shown in FIG. 31.

FIG. 31 illustrates a trigger dependent user info format in accordance with an embodiment. The trigger dependent user info format may include a TID bitmap field, a link bitmap field, a reporting information field, and a status code field.

The TID bitmap field can indicate the TIDs for which the reporting can be done. A value of 1 in the bit position i of the TID bitmap can indicate to the receiving entity that the timing information for packets that correspond to TID i can be provided. A value of 0 in the bit position i of the bitmap can indicate to the receiving entity that the timing information for packets that correspond to TID i need not be provided.

The link bitmap field can indicate the link(s) on which the reporting can be done. A value of 1 in the bit position i of the link bitmap can indicate to the receiving entity that the timing information can be reported for the link with link ID equal to i. A value of 0 in the bit position i of the link bitmap can indicate to the receiving entity that the timing information need not be reported for link with link ID equal to i.

The reporting information field can carry an encoding that an indicate what type of timing information can be reported.

The status code field can provide status information.

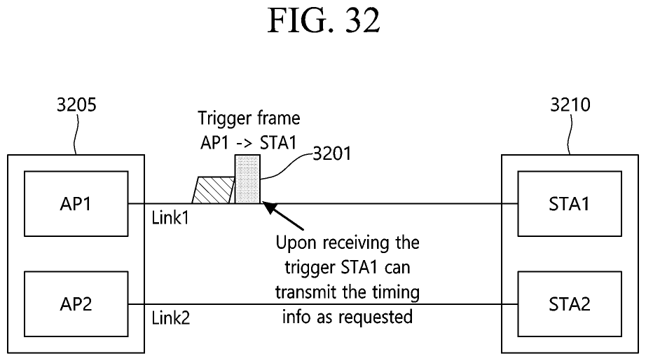

FIG. 32 illustrates a triggering example in accordance with an embodiment. In particular, FIG. 32 illustrates AP1 and AP2 affiliated with AP MLD 3205 and STA1 and STA2 affiliated with non-AP MLD 3210. Furthermore, FIG. 32 illustrates STA1 associated with AP1 on link 1 and STA2 associated with AP2 on link 2. As illustrated, when AP1 needs the timing information from STA1, AP1 can transmit a trigger frame 3201 to STA1 to fetch the timing information. Upon receiving the trigger frame, STA1 can transmit the timing information.

In some embodiments, a device that supports any of the procedures described in this disclosure can advertise the support in one or more frames that it transmits. For instance, if the device is an AP MLD, then it can advertise the support in management frames such as beacons, probe responses, (Re) association responses, among others that it transmits. The advertisement can be in the form of a field (e.g., a bit) that can be set to a predetermined value (e.g., 1) to indicate the presence of the support and to another predetermined value (e.g., 0) to indicate absence of the support. If the device is a non-AP MLD, then it can advertise the support in management frame such as probe requests, (Re) association requests, among others that it transmits. The advertisement can be in the form of a field (e.g., a bit) that can be set to a predetermined value (e.g., 1) to indicate the presence of the support and to another predetermined value (e.g., 0) to indicate absence of the support.

A requesting entity and the responding entity in this disclosure can be any device. E.g., the requesting entity can be an AP and the responding entity can be a STA. In another example, the requesting entity can be a STA and the responding entity also be an AP. In another example, the requesting entity can be a STA and the responding entity can be a peer STA. In another example, the requesting entity can be an AP and the responding entity can also be an AP.

The fields described in this disclosure can be a part of any of the frames in the standard and are not limited to those described above.

In the signaling indicated in this disclosure, one or more of the depicted fields can be missing or other additional fields can be present.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first device associated with a second device in a wireless network, the first device comprising:
at least one station (STA) affiliated with the first device;
a processor coupled to the at least one STA, the processor configured to:
transmit a request frame to the second device, wherein the request frame requests permission from the second device in order for the first device to provide to the second device timing information for packets transmitted to the second device;
receive a response frame from the second device indicating acceptance to receive the timing information from the first device; and
transmit the timing information to the second device.

2. The first device of claim 1, wherein a plurality of links are established between the first device and the second device and the timing information is information for packets associated with a particular link from the plurality of links between the first device and the second device.

3. The first device of claim 2, wherein the process is further configured to:
determine that a first link between the first device and the second device is congested;
transmit the request frame and receive the response frame on a second link between the first device and the second device; and
transmit the timing information on the first link between the first device and the second device.

4. The first device of claim 2, wherein the request frame and the timing information are transmitted on different links.

5. The first device of claim 2, wherein the request frame and the timing information are transmitted on a same link.

6. The first device of claim 1, wherein the timing information is transmitted on an on-demand basis as determined by the first device based on traffic conditions between the first device and the second device.

7. The first device of claim 1, wherein the timing information is transmitted after receipt of a trigger frame from the second device.

8. The first device of claim 1, wherein the STA is an access point (AP) STA or a non-AP STA.

9. The first device of claim 1, wherein the processor is further configured to advertise a capability to provide the timing information to the second device.

10. The first device of claim 1, wherein the timing information is related to an enqueue time or an expiration time.

11. A first device associated with a second device in a wireless network, the first device comprising:
at least one station (STA) affiliated with the first device;
a processor coupled to the at least one STA, the processor configured to:
transmit a request frame to the second device, wherein the request frame requests that the second device provide timing information for packets transmitted to the first device;
receive a response frame from the second device indicating acceptance to provide the timing information to the first device; and
receive the timing information from the second device.

12. The first device of claim 11, wherein a plurality of links are established between the first device and the second device and the timing information is information for packets associated with a particular link from the plurality of links between the first device and the second device.

13. The first device of claim 12, wherein the processor is further configured to:
determine that a first link between the first device and the second device is congested;
transmit the request frame and receive the response frame on a second link between the first device and the second device; and
receive the timing information on the first link between the first device and the second device.

14. The first device of claim 12, wherein the request frame and the timing information are communicated on different links.

15. The first device of claim 12, wherein the request frame and the timing information are communicated on a same link.

16. The first device of claim 11, wherein the timing information is requested on an on-demand basis as determined by the first device based on traffic conditions between the first device and the second device.

17. The first device of claim 11, wherein the timing information is received after transmission of a trigger frame from the first device.

18. The first device of claim 11, wherein the STA is an access point (AP) STA or a non-AP STA.

19. The first device of claim 11, wherein the processor is further configured to advertise a capability to receive the timing information to the second device.

20. The first device of claim 11, wherein the timing information is related to an enqueue time or an expiration time.
